(19) United States
(12) Patent Application Publication
(10) Pub. No.: US 2009/0292418 A1
(43) Pub. Date: Nov. 26, 2009

(54) TRIP LOGGER

(76) Inventor: ROBERT L. Kuykendal, High Ridge, MO (US)

Correspondence Address: CHARLES C. MCCLOSKEY, 763 S. NEW BALLAS ROAD STE. 170, ST. LOUIS, MO, 63141, US

(21) Appl. No.: 12/126,159

(22) Filed: May 23, 2008

(51) Int. Cl. G06F 7/00

(52) U.S. Cl. 701/35; 701/29

(57) ABSTRACT

An accessory device for vehicles, such as automobiles and light trucks, that automatically creates a log of all trips taken by the vehicle. The log includes date, time, odometer reading, stopping location, and miles traveled from previous stop. The device produces a log in a format that meets the regulation of tax collecting agencies and accounting firms regarding the separation of mileage by personal use and business use. The device allows a user to purge the log as desired.

### BACKGROUND OF THE INVENTION

The trip logger generally relates to tracking vehicles and their usage, and more specifically to a tracking and reporting system for producing mileage and expense logs suitable for submission to a tax collecting agency.

People who drive or operate vehicles such as automobiles, trucks, and the like, often have both personal use and business use of the vehicle. Drivers that have partial personal and partial business use of a vehicle must maintain an accurate log of daily vehicle use to meet IRS regulations and GAAP (Generally Accepted Accounting Principles). The logs generally include detailed mileage from location to location and categories desirable by each driver. The regulations impose the burden of an accurate log upon drivers. However, drivers in the bustle of daily business endure distractions or forgetfulness that make accurate logging a challenge to individuals. Often drivers construct their logs from memory after the operation of the vehicle each day leading to inaccuracies and potential inflation. Drivers have sought convenient ways over the years for a cost effective automatic log of mileage without the driver needing to remember to do so. Other drivers seek an automatic system with a purge capability where the drivers view the tracking as invasive of their privacy.

### DESCRIPTION OF THE PRIOR ART

Over many miles of road and countless expense reports, businesses of all kinds that use automobiles and trucking companies have sought devices and methods to record usage of vehicles for tax purposes. Trucking companies have used a system of odometer readings, GPS coordinates, speedometer readings, engine RPM and other status readings, and other data to regulate driver behavior, owner behavior, and compliance of both drivers and owners with Dept. of Transportation, National Highway and Transportation Safety Administration, and other regulatory agencies. However, these prior art systems have yet to provide a log of travel suitable for accounting purposes or for submission of a mileage report to a tax collecting agency.

The U.S. Pat. No. 5,917,434 to Murphy describes a tax meter or a trip meter for a truck. This patent emphasizes the usage of GPS regarding the accuracy of the meter for fare output. Using this patented device, a meter produces an incontrovertibly accurate display of elapsed time and distance traveled for taxis or trucks.

The U.S. Pat. No. 6,087,965 also to Murphy describes monitoring and controlling a commercial vehicle during its travels. This patent utilizes an odometer that interfaces with a GPS receiver and computer. This patent emphasizes usage of the GPS receiver to improve the accuracy of the odometer.

The U.S. Pat. No. 4,307,455 to Juhasz has a computer system that accepts sensor data, computes the status of a system, and monitors the system for anomalies.

The U.S. Pat. No. 4,303,850 also to Juhasz shows a clock that includes a battery backup power supply.

The U.S. Pat. No. 4,258,421 also to Juhasz provides a system that monitors engine performance. This patented system includes sensors, a processing computer, and printer for producing reports suitable for diagnostics and operational recordkeeping.

The U.S. Pat. No. 6,917,176 to Schmepf combines GPS with computer monitoring for the inspection of gas pipes by a robot.

The U.S. Pat. No. 6,751,452 to Kupczyk et al. describes a vehicle communication system over the internet.

The U.S. Pat. No. 6,047,237 to Michmerhuizen provides a method for calibrating a vehicle compass within the metal mass of vehicle.

And, the U.S. Pat. No. 6,917,434 to Ohta illustrates a digital odometer.

The present invention overcomes the difficulties of the prior art. The present invention includes a system and method of collecting and printing mileage information for a vehicle for submission to a tax collecting agency. Though the present invention has a description referring to a driver and a vehicle, such as an automobile or truck, the invention also applies to operators and vehicles and equipment that track hours in use in contrast to miles in use for automobiles.

### SUMMARY OF THE INVENTION

Generally, the present invention provides a computer module that receives inputs regarding odometer readings, date, time, and coding of use for a trip then provides an output of mileage in a report form. The report form displays the mileage and use code along with a date and time suitable for submitting to a tax collecting agency upon demand. The computer module, through the inputs, tracks the odometer readings with little intervention by a driver of a vehicle, such as an automobile or other moving equipment. Also, the computer module receives GPS signals and provides GPS coordinates in the report form.

There has thus been outlined, rather broadly, the more important features of the invention in order that the detailed description thereof that follows may be better understood and that the present contribution to the art may be better appreciated. The present invention also includes a battery backup, GPS receiver, and USB type port and like connections for output. Generally, the present invention tracks the odometer readings in real time from the vehicle, converts those into miles driven, and couples them with a code for business or personal use then produces a report listing the mileage entries for each trip or each day. The invention can produce a report on demand by the user and for a time period selected by the user, such as a day, week, month, quarter, or year among others. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved trip logger that avoids the disadvantages of the prior art.

Another object is to provide such a trip logger that produces data in a format acceptable by a tax collecting authority and other accounting software.

Another object is to provide such a trip logger that tracks mileage automatically with little intervention by a driver of a vehicle. These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 illustrates the components of the present invention;

FIG. 2 shows a block diagram listing the sequence of operating the device; and,

FIG. 3 provides a sample output of the device.

The same reference numerals refer to the same parts throughout the various figures.

### DESCRIPTION OF THE PREFERRED EMBODIMENT

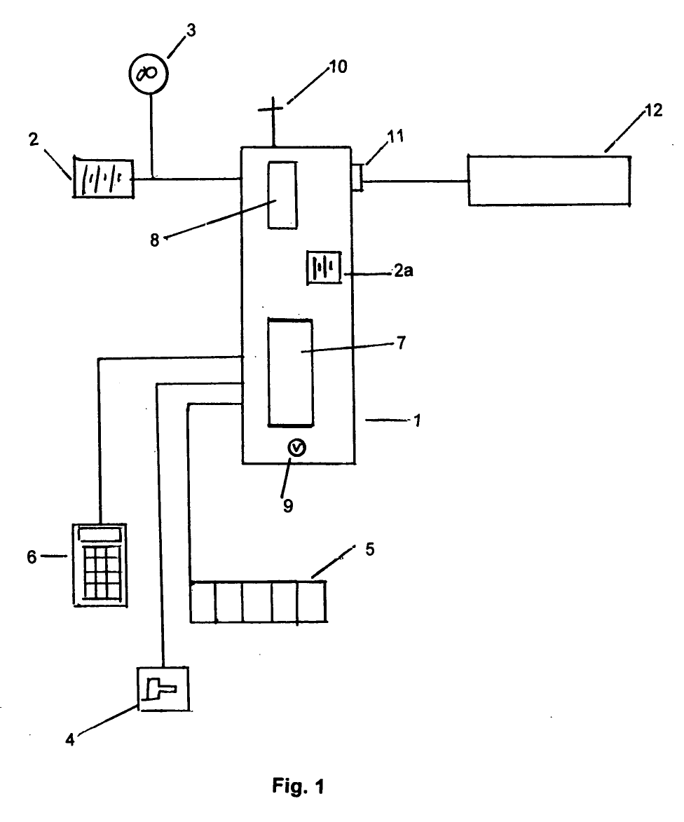

The present invention overcomes the prior art limitations and provides a device for logging mileage on vehicle trips that produces a report acceptable by a tax collecting agency. Turning to FIG. 1, the device of the present invention has a programmed computer module 1 which receives inputs, processes the inputs, and produces an output, generally as a log file. The log file can then be printed by a user and submitted to a tax collecting agency.

The module receives electrical power from the vehicle's active electrical system as at 3 or from the vehicle's battery as at 2. The module also includes its own onboard power source such as the battery as at 2a. The module collects inputs including readings from an odometer 5, the vehicle ignition switch 4, an internal clock 9, and a keypad 6 or other manual data entry device. The module receives a key input from the odometer. The odometer provides a mechanical—analog- or electrical—digital-reading regarding the miles traveled by a vehicle upon a trip. Digital odometer readings enter the module directly for processing. Analog readings generally require converting the mechanical revolutions of the odometer into electrical pulses suitable for processing by the module. The present invention includes an alternate embodiment that has a converter for application upon vehicles with a mechanical odometer. Next, the vehicle ignition switch provides another input useful to the module. The vehicle ignition switch, as at 4, that indicates to the module when the ignition is turned on or off. The ignition switch also provides power to accessories from the vehicle electrical system for operation or charging of batteries with an accessory such as the module. The module may also receive input from a transmission drive selector, as at 4a, which can be a substitute for the vehicle ignition switch. The transmission drive selector may indicate to the module that the vehicle's engine is on, and vehicle electrical power is available, but that the transmission is in Park. The module then deduces that the vehicle is not in motion and temporarily suspends calculation of mileage and tracking of odometer readings.

The module also has an output port 11, such as a USB port, plentiful memory 7 for recording log entries, and processing means as at 8 for organizing, recording, and outputting log data record files and other output. In an alternate embodiment, the module receives GPS coordinates through an onboard GPS receiver or antenna as at 10, and outputs log data to a user through an LCD screen as at 12.

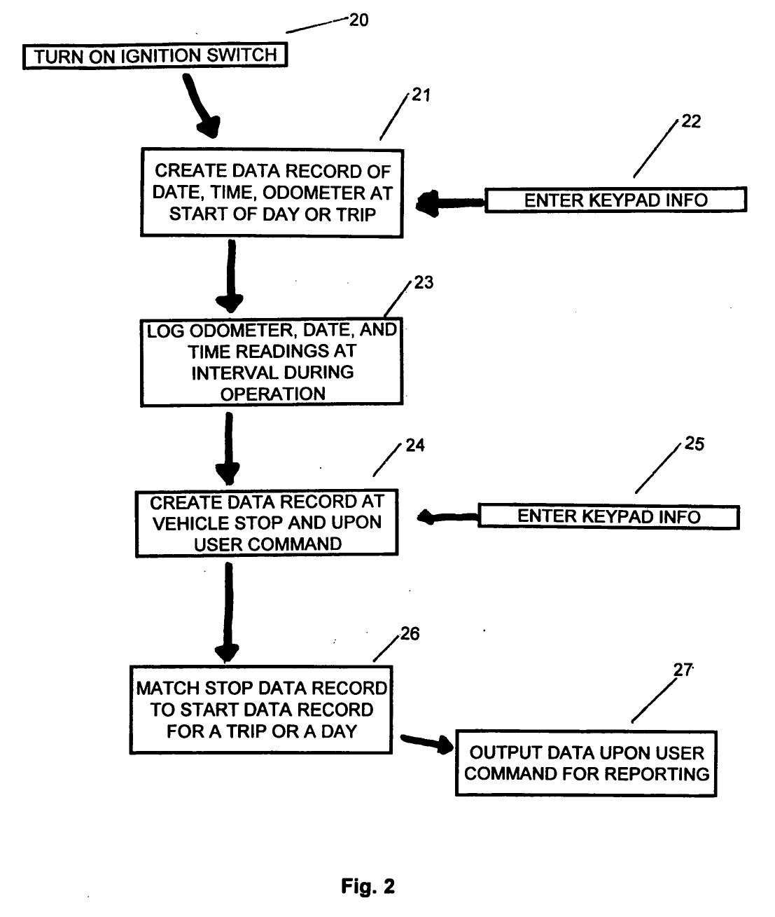

Following installation in a vehicle, FIG. 2 then describes the operation of the device of the present invention in block diagram form. First, when the user turns on the ignition switch as at 20, the module creates a data record as at 21 to log the date, time, odometer reading, and any keypad data provided as text, numerals, or code by the user as at 22. In an alternate embodiment, the module also establishes a GPS location fix upon the appropriate minimum number of satellites. Upon using the keypad, the user may enter a location name or location code which the module will store regardless of the ignition being on or off because the module has its own battery. The driver may also use the keypad to identify the vehicle owner and the privilege level of the driver, to control operations of the device, to create abbreviations or codes for locations or other uses in the data record, and to associate GPS coordinates with a location name for repeated use by the processor in constructing the log. Privilege level refers to the discretion granted by a vehicle owner, or a licensing body, to a vehicle operator for driving the vehicle. Privilege levels may range from few, such as to work only during daylight, to many such as vehicle operations nationwide and in all weather and darkness. Upon the user entering a privilege level on the keypad, the module can check for variances from the operation of the vehicle with those privileges granted to the specific user. Upon detecting a variance, the module illuminates an optional light or an optional sound thereon and makes a note in the log. Though a keypad is described, privilege levels may be entered using a coded ignition key, an ignition key with an onboard computer chip, and a plastic magnetic stripe card with a cooperating reader upon the module among other devices.

Second, during operation of the vehicle, the module tracks the odometer reading, and alternatively the GPS coordinates, at a time interval as at 23. The time intervals range from every minute to approximately each hour during vehicle operation. During most usage of the invention, the keypad accepts entries and builds the log file generally at anytime when the vehicle operates. Third, when the driver stops the vehicle at its destination as at 24, the driver creates a data record using the keypad as at 25. This keypad entry accepts the same information as identified above. The user provides this keypad entry to identify a destination or provide other brief explanation for stopping the vehicle. The module then matches the end of trip data record to odometer and time readings from other input sources as at 26. The module stores the data records indefinitely subject to memory limits and provides the data records in a log format upon request by the user as at 27.

The methods of the present invention may be incorporated within computers now installed upon automobiles and other vehicles. Those methods producing a log of data regarding vehicle operations suitable for a tax collecting agency using a processor and include the following steps:

1) receiving an input about the vehicle status from a vehicle ignition switch or a transmission drive selector and logging that input within the processor;

2) logging the date, time, and odometer reading at the start of a trip or a day within the processor;

3) receiving alphanumeric characters from a keypad into the processor that relate to the start of a day or a trip;

4) logging odometer readings from time to time during operation of a vehicle within the processor;

5) creating a record of the date, time, odometer reading, and alphanumeric code within the processor from time to time during a trip, when a vehicle stops, or at the end of a day or a vehicle trip;

6) matching the record when a vehicle stops with the record at the start of a day or trip by the processor; and,

7) providing output of mileage and usage from said processor upon command of a user generally in a report form.

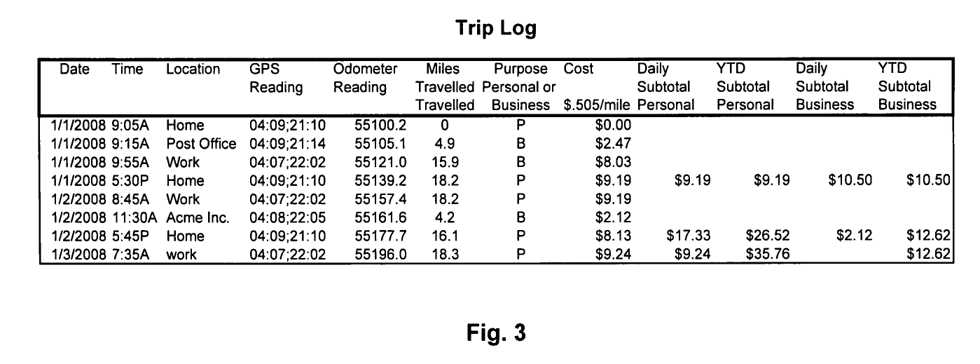

Fourth, the user then downloads daily, weekly, monthly, or annual usage logs from the device as at 27. The usage logs are delivered by the module through the output port for conversion into a format suitable for the user such as a spreadsheet, as in FIG. 3, or an accounting software package. A spreadsheet includes Excel® and an accounting software package includes Quicken®, Peachtree®, or TurboTax®. FIG. 3 shows a typical spreadsheet that identifies the date, time, GPS coordinates, and odometer reading when a vehicle passes a location. The spreadsheet further provides the miles traveled between stops and calculates the automobile expense using the current I.R.S. mileage rate, updated from time to time. The spreadsheet also displays the usage code, generally personal or business, keyed in by the user generally at a stop of the vehicle as in step 25 described above. When an external device connects to the output port, such as a Compact Flash® storage device, and the driver enters a predetermined code, the processor downloads a portion of the data record log or the log into the external device. The driver then relocates the external device to a computer for further processing upon a spreadsheet or accounting software package. This method of use has similarities with the download and relocation of pictures from a digital camera to a computer.

From the aforementioned description, a trip logger has been described. The trip logger is uniquely capable of associating odometer readings with location names or GPS coordinates for later output in a format sufficient for the regulations of a tax collecting agency. The trip logger and its various components may be manufactured from many materials, including but not limited to, polymers, polyvinyl chloride, high density polyethylene, polypropylene, nylon, steel, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device producing data of vehicle operations suitable for a tax collecting agency, comprising:
a module receiving external power, said module receiving inputs, and said module providing outputs;
said inputs including odometer readings, vehicle status indicators, and alphanumeric characters; and,
said output including data identifying the mileage between a plurality of paired locations upon a route traveled by a vehicle.

2. The vehicle data producing device of claim 1 further comprising:
said module including a memory, and a processor receiving said inputs and producing said outputs; and,
a keypad in communication with said processor.

3. The vehicle data producing device of claim 1 further comprising:
said inputs including GPS location fix data.

4. The vehicle data producing device of claim 1 wherein said odometer readings are digital.

5. The vehicle data producing device of claim 1 further comprising:
said output including an LCD display proximate said module.

6. The vehicle data producing device of claim 1 further comprising:
said output including a port suitable for connection to an external device; and,
said output providing date, time, location code, odometer readings, miles traveled, and a usage code denoting at least personal and business usages.

7. The vehicle data producing device of claim 1 further comprising:
said module receiving an input from said vehicle status indicators, logging the date, time, and odometer reading at the start of one of a day or a trip, receiving alphanumeric characters from a keypad for association with the start of a day or a trip, logging odometer readings from time to time during operation of a vehicle, creating a record of the date, time, odometer reading, and alphanumeric code at one of an interval during a trip, at the end of the day, or when a vehicle stops, matching the record when a vehicle stops with the record at the start of a day or trip, and providing output of mileage and usage upon command of a user.

8. The vehicle data producing device of claim 1 further comprising:
said module having an internal power source including a battery and a clock.

9. The vehicle data producing device of claim 1 further comprising:
said vehicle status indicators including a vehicle ignition switch status and a transmission drive selector.

10. A method of producing a log of data regarding vehicle operations suitable for a tax collecting agency using a processor, comprising:
receiving an input from one of a vehicle ignition switch or a transmission drive selector and logging said input within said processor;
logging the date, time, and odometer reading at the start of one of a day or a trip within said processor;
receiving alphanumeric characters from a keypad into said processor for association with the start of a day or a trip;
logging odometer readings from time to time during operation of a vehicle within said processor;
creating a record of the date, time, odometer reading, and alphanumeric code within said processor at one of an interval during a trip, when a vehicle stops, or at the end of a day or a vehicle trip;
matching the record when a vehicle stops with the record at the start of a day or trip by said processor; and,
providing output of mileage and usage from said processor upon command of a user.
